(19) United States
(12) Patent Application Publication
(10) Pub. No.: US 2011/0247968 A1
(43) Pub. Date: Oct. 13, 2011

(54) Material Sorting Apparatus

(75) Inventor: Andrew Mills, Littleborough (GB)

(73) Assignee: KEN MILLS ENGINEERING LIMITED, Littleborough (GB)

(21) Appl. No.: 13/167,839

(22) Filed: Jun. 24, 2011

Related U.S. Application Data
(63) Continuation of application No. 12/514,993, filed on Jun. 9, 2009, now abandoned.

(30) Foreign Application Priority Data
Nov. 15, 2006 (GB) 0622726.8

(51) Int. Cl. B07B 9/02

(52) U.S. Cl. 209/12.1

(57) ABSTRACT

A material sorting apparatus comprises a perforated screen (3), for example a drum, adapted to be moved around an endless track. Means are provided for sucking air through the screen (3) inwardly of the track in a predetermined area (7) thereof. A material to be sorted is supplied to the apparatus such that it falls under gravity in close proximity to said predetermined area (7) of the track in order that laminar material is selectively sucked towards the surface of the screen (3). This material is transported in contact with the screen (3) while the screen is moving through and out of the predetermined area (7) but is released from the suction forces when the screen (3) moves out of said predetermined area (7). A first collection region is located beneath a region (8) of the apparatus adjacent the predetermined region (7) of the track into which material not transported by the screen (3) can fall. A second collection region (13) is located adjacent an area of the track other than said predetermined area (7) to receive material which has been transported in contact with the screen (3) out of the predetermined area (7) of the track.

### CROSS-REFERENCE TO RELATED U.S. APPLICATIONS

This is a continuation of U.S. patent application Ser. No. 12/514,993 filed May 14, 2009, which is a national stage filing of PCT/GB2007/004250, having an international filing date of Nov. 8, 2007 which claims priority of GB Application No. 0622726.8, filed Nov. 15, 2006.

### BACKGROUND OF THE INVENTION

1. Field of the Invention

The present invention relates to a material sorting apparatus.

2. Description of Related Art Including Information Disclosed Under 37 CFR 1.97 and 37 CFR 1.98.

The sorting of materials is important in many industries. The present invention is particularly adapted to sort paper and other flexible, laminar materials, such as plastics sheets, cloth or rags from other types of materials which have a greater bulk. The invention is therefore suitable for use in the waste management industry where material recycling is important. Waste collected from homes, on-street bins and offices tends to comprise a mixture of materials including waste paper, cardboard, cans, plastic bottles, glass bottles and other materials that may be recyclable. All of this material needs to be sorted. The splitting of laminar materials such as plastics sheeting and films and, in particular paper, away from bulkier material such as bottles, cups, cans and the like is an important part of the sorting process. The apparatus of the present invention has, therefore, been developed for this particular use although it will be appreciated that it may have wider application in other industries.

### BRIEF SUMMARY OF THE INVENTION

According to the present invention there is provided a material sorting apparatus comprising:

a perforated screen adapted to move around an endless track;

means for moving the screen around the track;

means for sucking air through the screen inwardly of the track at a predetermined area of the track;

a material supply means for supplying material to be sorted such that it falls under gravity in close proximity to said predetermined area of the track in order that laminar material is selectively sucked towards the surface of the screen, is held by suction forces in contact with the screen while being transported by the screen through and out of said predetermined area of the track, and is released from suction forces when the screen moves out of said predetermined area of the track;

a first collection area located beneath a region adjacent the predetermined area of the track into which material not transported by the screen can fall; and

a second collection area located adjacent an area of the track other than said predetermined area to receive material which has been transported in contact with the screen out of the predetermined area of the track.

Preferably, the predetermined area of the track is located where the screen moves downwardly through an arcuate portion of the track.

Preferably also, the screen is enclosed in a housing into which the material to be sorted is introduced through an inlet defined in an area located substantially above the perforated screen.

Other preferred but non-essential features of the invention are described in the dependent claims.

### BRIEF DESCRIPTION OF THE SEVERAL VIEWS OF THE DRAWINGS

Embodiments of the present invention will now be described by way of example with reference to the accompanying drawings.

FIG. 1 is a side view of a first embodiment of material sorting apparatus.

FIG. 2 is an end view of the apparatus shown in FIG. 1 in the direction of the arrow II.

FIG. 3 is a schematic side view of an alternative form of perforated screen for use in a second embodiment of material sorting apparatus.

FIG. 4 is a schematic view of a diagram showing two perforated screens acting in combination for use in a third embodiment of material sorting apparatus.

FIG. 5 is a schematic view of a diagram showing two perforated screens acting in combination for use in a fourth embodiment of material sorting apparatus.

### DETAILED DESCRIPTION OF THE INVENTION

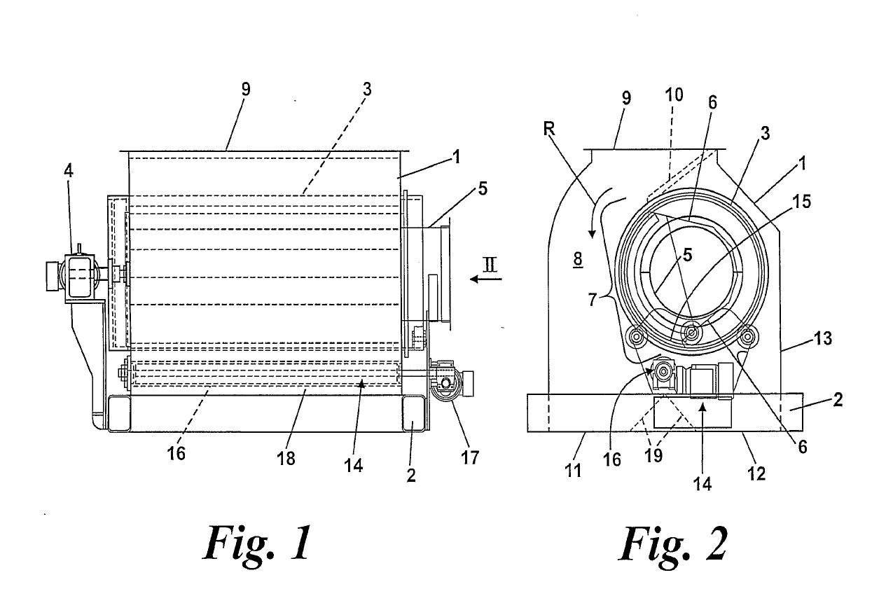

A first embodiment of material sorting apparatus is shown in FIGS. 1 and 2 and comprises a housing 1 that is mounted on bracket 2 to cover a perforated screen, which is adapted to move around an endless track. In this embodiment, the perforated screen comprises a cylindrical drum 3 which is rotatably mounted such that is can rotate about its longitudinal axis, which is retained substantially horizontal, around a circular track defined by its circumference. The drum 3 is driven by a motor 4 that is mounted externally of the housing 1. Means (not shown), such as an air pump or fan, are also provided for sucking air out of the interior of the drum 3 via duct 5 while the apparatus is in use. Air is, therefore, sucked through the perforations provided in the drum 3 from its exterior to its interior prior to discharge from the housing 1. The drum can be made of any suitable material such as a wire mesh, perforated plate or other suitable material through which air can pass.

Located within the drum 3 is a suction hood 6 that shields part of the internal periphery of the drum 3 from suction forces leaving a predetermined area 7 of the drum 3 uncovered on which the suction forces can act. As shown in FIG. 2, this predetermined area 7 of the drum 3 is located along one side of the drum 3 adjacent a wide interior region 8 of the housing 1. The drum 3 is also arranged to rotate in a direction shown by the arrow R in FIG. 2 such that the drum 3 moves along its track in a substantially downward direction through the region 8.

The housing 1 is provided with an inlet 9, which is located substantially vertically above drum 3 and through which material to be sorted can be fed on a continuous basis or an intermittent basis during operation of the apparatus. Within the housing 1, a baffle 10 is located at one side of the inlet 9 to direct material into the interior region 8 and to prevent material from passing around the other side of the drum 3. Located beneath the drum 3 are two collection regions served by outlets 11 and 12. The outlet 11 is located directly beneath the interior region 8. Material which is not transported by the drum 3, as is described below, falls through the region 8 and thence through this outlet 11 for collection by an appropriate means (not shown) such as a suitable receptacle or conveyor for further processing. The second outlet 12 is located in a region 13 adjacent the lower portion of the drum 3, which is outside of the region 8.

This region 13 receives material which has been transported in contact with the drum 3 out of the region 8. Once in the region 13, the drum 3 releases the material so that it can fall through the second outlet 12 for collection by another appropriate means (not shown) such as a second receptacle or conveyor.

As the apparatus is primarily intended to sort paper and other flexible, laminar materials, such as cloth or rags from other types of materials which have a greater bulk, a splitter device 14 is provided to assist in the sorting process. The splitter device 14 is positioned adjacent the lower boundary 15 between the regions 8 and 13 in the housing 1 and acts to prevent the passage of bulky material from the region 8 into the region 13 under the action of the drum 3. Laminar material which is adhered to the surface of the drum 3 is unaffected by the splitter device 14. However, some lightweight but bulky materials may be transported by the drum 3 and these are knocked away from the drum 3 when contacted by the splitter device 14.

In this embodiment, the splitter device 14 comprises a roller 16 which is substantially horizontally mounted parallel to the drum 3 and is rotated by a motor 17 in a direction opposite to that of the drum 3. The size of the gap 18 between the surfaces of the roller 16 and the drum 3 is used to determine the size and type of materials that can be sorted by the apparatus. In some embodiments, therefore, the roller 16 can be movable in order that the size of the gap 18 can be varied as required for any given sorting operation. In other embodiments, the roller 16 can be replaced by a baffle plate or similar, that can be made moveable, either towards or away from the drum 3 to control the size of the gap 18. However, in the illustrated embodiment rotation of the roller 16 prevents the gap 18 from becoming fouled by materials which may stick to or accumulate along the edge of a stationary splitter means 14 such as a baffle plate. To prevent material sticking to the roller 16 and being carried between the regions 8 and 13, scraper plates 19 can be provided adjacent the lower part of the roller 16 to remove such adhering material and direct it through one or other of the outlets 11 and 12.

In use, the drum 3 is rotated in the direction of the arrow R and air is extracted from the interior of the drum 3 so that air is also sucked out of the interior of the housing 1 through the predetermined area 7 of the drum 3. Material to be sorted is then introduced into the housing 1 through the inlet 9 and falls into the region 8. In this region 8, the air which is being sucked out of the housing 1 into the drum 3 carries lightweight, laminar material such as paper, scraps of cloth, plastics sheets and the like towards the drum 3 where the suction forces hold it against the surface area 7 of the drum 3. As the drum 3 is rotating, the material so held is transported out of the region 8 of the housing 1 into the region 13 beneath the drum 3. As the material passes from the region 8 into the region 13, the splitter device 14 operates to prevent any lightweight but bulky material that may be being held against the drum 3 from passing into the region 13. Once in the region 13, the suction forces no longer act on the material in view of the location of the suction hood 4. The material therefore falls under the action of gravity and passes out of the apparatus through the outlet 12 for collection and possible further processing. Material in region 8 which is not held against the surface of the drum 3 or which is knocked away from the drum 3 by the splitter means 14 is falls out of the housing 1 through the outlet 11 for separate collection.

It will be appreciated that the material which is transported by the drum 3 need not be discharged downwardly but could be carried by the drum to an outlet at a different location in the housing than the outlet 12 as is convenient for the location of the apparatus in a sorting operation.

The speed of rotation of the drum 3 and the intensity of the suction forces applied through the drum 3 affect the sorting ability and sensitivity of the apparatus. Preferably, therefore, the apparatus is arranged to enable these to be independently variable and selectable from a range of variables so that the apparatus can be set up to sort different mixtures of materials.

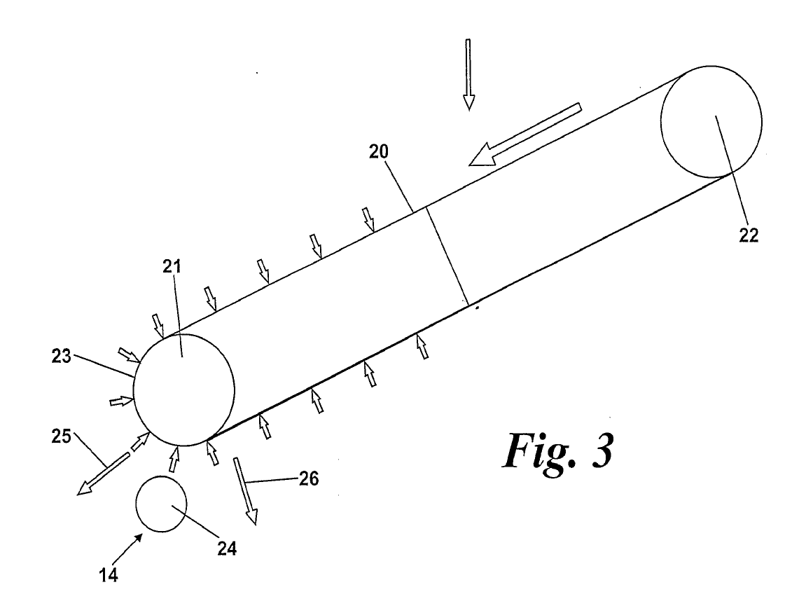

It will also be appreciated that the perforated screen need not be in the form of a drum 3, as shown in FIGS. 1 and 2. In another embodiment of apparatus, for example, the perforated screen can take the form of a belt that is rotated around an endless track. Such an arrangement is shown schematically in FIG. 3 wherein a perforated belt 20 is arranged to travel around an inclined track about lower and upper rollers 21, 22 respectively. Air is sucked through a predetermined region 23 of the track comprising the lower portion of the belt and in particular around the region where the belt moves downward around the lower roller 21, as indicated by the arrows. The belt 20 rotates so that its upper surface travels downwards into the predetermined area 23 of the track.

As in the first embodiment, material to be sorted is dropped on to the belt 20 from above so that it is carried downwards by the belt into the predetermined region 23. When the belt 20 begins to move through an arcuate portion of the track around the roller 21, lightweight, laminar material will be held against the belt by suction forces but bulkier, heavier material will fall off the belt 20. A splitter device 14 such as a roller 24 can be used as in the first embodiment. Material which is not held against the surface of the belt 20 can then be collected on one side of the device 14 and will move in the direction of the arrow 25 whereas material which is held against the belt 20 will pass around and can be collected on the other side of the roller 21, where it will be released from the belt 20 and move substantially in the direction of the arrow 26.

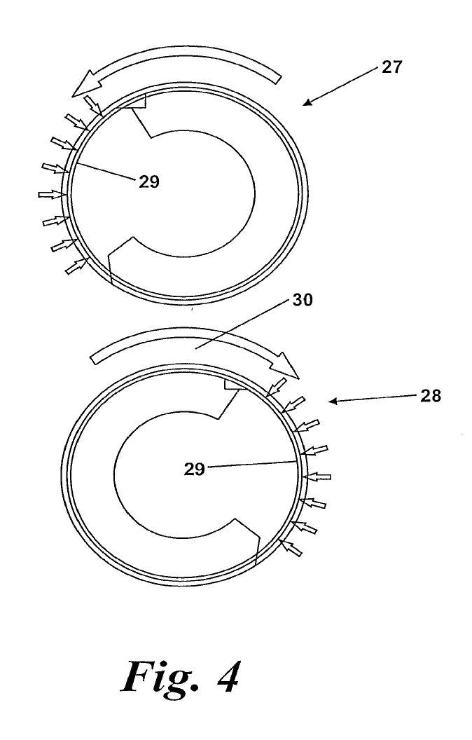

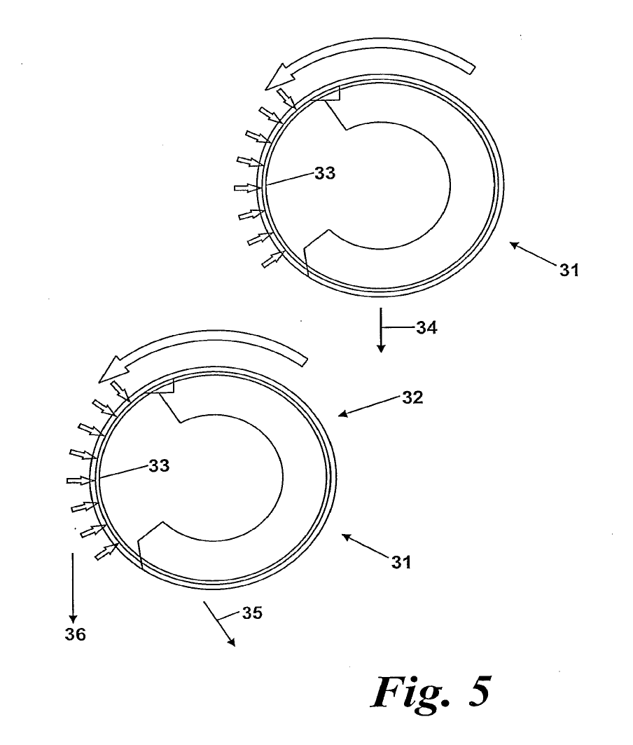

It is also envisaged that two or more perforated screens may be used in combination to accomplish more accurate sorting of material. For example, as shown in FIG. 4, two rotating drum arrangements 27, 28 could be mounted one above the other and adapted to rotate in opposite directions with the suction areas 29 on opposite sides of the apparatus from one another. In this way, material which is held by the upper drum 27 is carried into a region 30 between the two drums before it is released to fall onto the second drum 28 where a second sorting operation will again take place. The speed of rotation and the degree of suction applied to each of the drums 27, 28 can be varied, for example by making the suction greater in the upper drum 27 than in the lower 28 so that only more lightweight, flexible materials are held by the lower drum 28 thus enabling them to be sorted from heavier laminar materials sorted by the upper drum 27.

A different double screen arrangement is shown in FIG. 5, here two rotating drum arrangements 31, 32 are mounted one above the other but offset horizontally and adapted to rotate in the same direction as one another. Their suction areas 33 are arranged on the same sides of the drums 31, 32. In this embodiment, lightweight and/or laminar material which is held by the upper drum 31 is carried away from the lower drum 32 and discharged in the direction of the arrow 34 and only heavier and/or non-laminar material that does not adhere to the upper drum 31 is acted on by the lower drum 32. This material is then subjected to a second sorting operation by the lower drum 31 with lighter and/or laminar material discharged in the direction of arrow 35 and the now cleaned heavier and/or non-laminar material discharged in the direction of arrow 36. Hence, whereas in the embodiment shown in FIG. 4, the lightweight material that adheres to the upper drum 27 is subjected to a further sorting operation, in the embodiment shown in FIG. 5 it is the heavier, non-laminar material that is further cleaned. It has been found experimentally that while the upper drum 31 can remove approximately 90% of laminar and lightweight material, the lower drum 32 will remove most of the remaining 10%.

It will be appreciated, therefore, that by using multiple screen arrangements with appropriate differing suction forces and directions and speeds of travel, material sorting can be fine tuned according to the type of material it is desired to retrieve from a mixed batch of material.

I claim:

1. A material sorting apparatus, comprising:
a endless track;
a perforated screen moveable around said endless track;
means for moving the screen around the track;
means for sucking air through the screen inwardly of the track at a predetermined area of the track;
a material supply means for supplying material to be sorted, the material falling under gravity in close proximity to said predetermined area of the track, wherein laminar material is selectively sucked towards a surface of the screen, is held by suction forces in contact with the screen while being transported by the screen through and out of said predetermined area of the track, and is released from suction forces when the screen moves out of said predetermined area of the track;
a first collection area located beneath a region adjacent the predetermined area of the track into which material not transported by the screen can fall; and
a second collection area located adjacent an area of the track separate from said predetermined area to receive material transported in contact with the screen out of the predetermined area of the track.

2. An apparatus as claimed in claim 1, wherein the predetermined area of the track is located where the screen moves downwardly through an arcuate portion of the track.

3. An apparatus as claimed in claim 1, further comprising:
a splitter device located adjacent a lower boundary between the predetermined area of the track and the rest of the track.

4. An apparatus as claimed in claim 3, wherein the splitter device comprises a baffle or a roller.

5. An apparatus as claimed in claim 3, wherein the splitter device is movable in order that a gap between the splitter device and the surface of the perforated screen is variable.

6. An apparatus as claimed in claim 4, wherein the splitter device comprises a roller which is rotated in a direction opposite to that of the screen.

7. An apparatus as claimed in claim 4, wherein the splitter device comprises a roller and at least one scraper being provided to remove material adhering thereto.

8. An apparatus as claimed in claim 1, wherein the perforated screen comprises a drum rotated about a longitudinal axis thereof.

9. An apparatus as claimed in claim 8, wherein the longitudinal axis of the drum is substantially horizontal.

10. An apparatus as claimed in claim 8, wherein the predetermined area of the track is located at one side of the drum.

11. An apparatus as claimed in claim 1, wherein the perforated screen comprises a belt rotated around an endless track.

12. An apparatus as claimed in claim 11, wherein the belt travels around an inclined track about upper and lower rollers.

13. An apparatus as claimed in claim 12, wherein the predetermined region of the track comprises the lower portion of the belt where the belt passes around the lower roller.

14. An apparatus as claimed in claim 1, wherein a suction hood is used to shield that region of the drum outside of the predetermined region of the track from suction forces.

15. An apparatus as claimed in claim 1, wherein the screen is enclosed in a housing, the material to be sorted being introduced to the housing through an inlet defined in an area located substantially above the perforated screen.

16. An apparatus as claimed in claim 1, wherein the speed of rotation of the perforated screen and intensity of suction forces applied thereto are independently variable.

17. An apparatus as claimed in claim 1, further comprising two or more perforated screens adapted to operate in combination.

18. An apparatus as claimed in claim 17, wherein the speed of travel of each of the screens and/or the intensity of the suction force applied to each of the screens are different from one another.
